(19) United States
(12) Patent Application Publication
(10) Pub. No.: US 2005/0240978 A1
(43) Pub. Date: Oct. 27, 2005

(54) Interconnection between components of a home entertainment system

(75) Inventors: Jonathan M. Bowern, Crawley Down (GB); David J. Woolgar, Horsham (GB)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., 5621 BA eindhoven (NL)

(21) Appl. No.: 10/517,975

(22) PCT Filed: Jun. 6, 2003
(86) PCT No.: PCT/IB03/02645

§ 371 Date: Dec. 15, 2004

(30) Foreign Application Priority Data
Jun. 20, 2002 (GB) 0214215.6

(51) Int. Cl. H04N 7/16

(52) U.S. Cl. 725/133; 725/141; 725/153

(57) ABSTRACT

A system (200) and method are described for exchanging data such as software updates, menus and digital AV content (e.g. MPEG2 streams) between components (202, 206) of a home entertainment system (200) interconnected using analogue AV connections such as phono/RCA or (preferably) Scart (208, 214). A first component (202) indicates (222) to a second component (206) that a data exchange is planned utilising one or more available analogue AV connections (220). In response, the second component (206) adapts its processing to accommodate the data exchange, for example routing and processing exchanged data instead of handling it as analogue AV content. In this way, existing analogue AV connections (208, 214) may be used to transfer data from one component to another in a home entertainment system without perturbing normal analogue AV operation whilst saving standardisation and deployment costs associated with defining new connectors and cordsets for such data transfer.

The present invention relates to a home audio-visual (AV) entertainment system comprising consumer electronics components and specifically to a method of exchanging digital data between the components.

Home consumers are encouraged to interconnect their AV products (hereinafter referred to as components) in clusters typically centred around a presentation device such as a TV. In recent years such components (for example, set top boxes, DVD players, high-end TV, etc.) have become increasingly digital in that they operate under control of software embedded in firmware within the set. To extend the life of such components the software is arranged to be upgradeable in the field in order to fix bugs and/or to add new features. In some cases upgrading can be achieved by the component accessing software via a download channel, a method typically employed by set top boxes. However, other components, for example a high-end TV, may not have access to a download channel and to upgrade such components may require a costly service engineer visit.

Software upgrading is a technical activity with which ideally a consumer should have minimal or preferably zero involvement. In the earlier example set top boxes can perform upgrading without any involvement of the user. Similarly, a DVD player can be upgraded by a user simply inserting a suitable disc into the player. However, as set top boxes and DVD players are unable to transfer data to other components in the cluster, similar user-friendly upgrading of these other components is not possible.

Digital components like set top boxes and DVD players are able to source any manner of digital content including menu data and digital AV (e.g. MPEG2). In practice this capability is not exploited in the market since the capability for digital interconnection is not provided on such components or the components to which they interconnect (e.g. TVs). Furthermore, experience shows that the provision of new dedicated digital connectors on components combined with their widespread use by consumers is likely to be a slow process due to the need to agree industry standards, minimise the cost of implementation and educate users. However, there is a commercial need to implement digital interconnection between components, for example to preserve the quality of digital AV content.

It is an object of the present invention to solve these and other problems using a system and method to exchange data between components of a home entertainment system.

In accordance with the present invention there is provided a home entertainment system comprising a first component and a second component connected using one or more interconnections for exchanging analogue AV content between the components, the components being operable to:
exchange analogue AV content using said interconnections, and, during a time interval,
exchange data content using at least one of said interconnections, wherein, in relation to said time interval, the first component is operable to:
a) generate an indication, and
b) communicate the indication to the second component, and the second component is operable to:
I. receive the indication, and, in dependence on the indication,
II. adapt the processing of content associated with the at least one interconnection used for exchanging data content.

Components of an existing home entertainment system are interconnected utilising cordsets comprising standardised connectors and conductors suitable to convey AV content in the form of analogue signals, including but not limited to, composite video, component video, synchronisation signals and audio. Preferably, these analogue signals are conveyed at baseband between components of the system; however, they may also, or instead, be modulated onto an RF carrier, the modulated signal being transferred by wired or wireless means between components of the system. The interconnections used include, but are not limited to, cordsets utilising any combination of the following connector types: Belling-Lee, phono/RCA jack, S-VHS miniDIN, Peritel/Scart, audio-jacks. Preferably the home entertainment system is interconnected by means of Scart. The conductors used in a cordset will be specified to be compatible with the characteristics of signals they are intended to convey, an example being those specified for Scart cordsets in EN 50049-1: 1997.

The system of the invention utilises one or more such interconnections to exchange data content between components. However, unlike prior art techniques, the components may adapt their processing of content to ensure that there is no interference with the normal analogue AV operation of the system. This adapted processing includes, for a destination component receiving data from another component, preventing the component from interpreting the received data as analogue AV content; for example, a TV might inhibit the presentation of received data content. Furthermore, the adapted processing may also include the ability for the destination component to determine which interconnections are utilised to exchange data with the source component.

The invention may utilise any or all available analogue AV content interconnections to exchange data between components. In some embodiments only a single interconnection may be used, preferably this interconnection is Blanking (Scart, pin 16 with ground return, pin 14). The Blanking pin is appropriate because it has a high bandwidth (datarate) capability and also, being bus configured within a Scart interconnected system, it is compatible with point-multipoint as well as peer-peer data exchanges.

A source component, wishing to exchange data with one or more destination components, may generate an indication which is then communicated to the one or more destination components, which indication signifies that a data exchange mode is to be established between the source and destination components. It may in addition specify one or more interconnections to be used in the data exchange. A destination component may adapt its processing of content in dependence on the indication received.

The indication may be conveyed by embedding it within the data exchanged between components and be suitably decoded by a component participating in the data exchange. Many techniques are suitable for embedding the indication within the data and these are readily identifiable by the skilled person and will not be further referred to in the present description.

Alternatively, the indication may be conveyed by means of a separate interconnection, such as a spare AV interconnection or perhaps the Reserved pin of Scart (pin 12). In the former case, use of a spare connection may be inefficient in that a channel capable of handling high datarates is limited to a very low rate indication signalling task. In the latter case, use of the Reserved pin may require industry agreement and consequently may hinder or delay the adoption of the technique. A further option is to convey the indication via existing control means, including but not limited to wireless (e.g. using infrared or radio media) and Project50 (Scart, pin 10). A disadvantage of wireless control is the need for the components party to the data exchange to use the same medium and protocol. It is preferable that the indication is conveyed using Project50. A component requesting data transfer simply has to initiate a Project50 message to set up a source-destination for the data exchange, and use as a default Blanking (Scart pin 16) for the data exchange (or optionally indicate which interconnections shall be used for the exchange). A component which supports such a data exchange may respond accordingly and the exchange can take place in a controlled and managed fashion, as discussed in detail below.

Also in accordance with the present invention there is provided a method for exchanging data between a first component and a second component of a home entertainment system, which components are connected using one or more interconnections operable to exchange analogue AV content, the method comprising the steps of, for the first component:
a) acquiring data to exchange with the second component;
b) generating an indication which indicates a data exchange mode;
c) communicating the indication to the second component;
d) exchanging data with the second component using at least one of said interconnections; and
e) cancelling the indication to indicate a cessation of the data exchange mode,
   and the method comprising the steps of, for the second component:
   I. checking for an indication from components in the system;
   II. receiving the indication from the first component;
   III. exchanging data with the first component; and, in dependence on the indication,
   IV. adapting the processing of content associated with the at least one interconnection used for exchanging data content.

The method may be initiated by a component within the home entertainment system. The component acquires data for sending to another component in the system. Such data may be furnished by any means including, but not limited to, a data carrier such as CD, tape or disk and/or by downloading data from a remote location such as a server residing at a broadcaster, at a service provider, on a network or on the Internet. The component accesses the data utilising a suitable (for example built-in) media reader and/or server connection using methods known to the skilled person; particularly suitable examples are DVD players (which are inherently capable of reading CD-ROMs) and set top boxes (which can readily download data from a broadcaster, a network or the Internet). The component may then generate an indication to signal that a data exchange mode of operation is to be entered. The indication may include the identification of a destination component (or components) intended to receive the data. The indication may also include information notifying the destination component of the interconnections to be used for the data exchange. The destination component may send an acknowledgement of the indication to the first component, thereby confirming that the destination component will correctly handle the data exchange (for example by having determined, when indicated, the lines to be used for the data exchange as indicated by the first component and by processing the received signal as data rather than as an analogue AV signal). The acknowledgement may be a simple ACK of the indication signal prior to data exchange. Preferably it may be a more complex acknowledgement which is maintained during the data exchange—in this way the components exchanging data can accommodate any dynamic changes (for example the destination component might signal in the acknowledgement alterations in the availability of lines presently being used for data exchange) while the data exchange is occurring. In such circumstances the first component may be given options to continue the data exchange using different lines, or alternatively discontinue the data exchange and resume or retry later.

To assist with routing of data for the data exchange, the first component may distribute the indication to all components of the home entertainment system thereby allowing the components to configure themselves in dependence on the indication. Preferably the indication is performed by means of Project50 (Scart pin 10) this being connected in bus fashion to all components in a Scart interconnected home entertainment system.

According to the present invention there is provided a use of an at least one interconnection operable to exchange analogue AV content between components of a home entertainment system to, alternatively, exchange data between said components and, during the data exchange, to adapt the processing of content associated with the at least one interconnection by the components. As discussed earlier, the exchange of data using such interconnections may be signalled by means of an indication.

It is envisaged that the present invention can be used to offer a datarate of at least 10 kbit/sec for data exchange between components utilising a single audio connection, assuming encoding of at least 1 bit per Hertz of bandwidth. Clearly, higher rates should be achievable utilising the video connections, perhaps in the region of 10 Mbit/sec or more per video connection. The present invention permits more than one analogue AV connection (e.g. audio, video, Blanking, etc.) to be used for the data exchange. It also allows simultaneous exchange (using different analogue AV connections) of analogue AV content and data between first and second components of a system. Preferably, interconnections embodied within Scart are suitable for use by the invention since home entertainment systems are already interconnected using Scart.

Further features and advantages will now be described, by way of example only, with reference to the accompanying drawings in which:

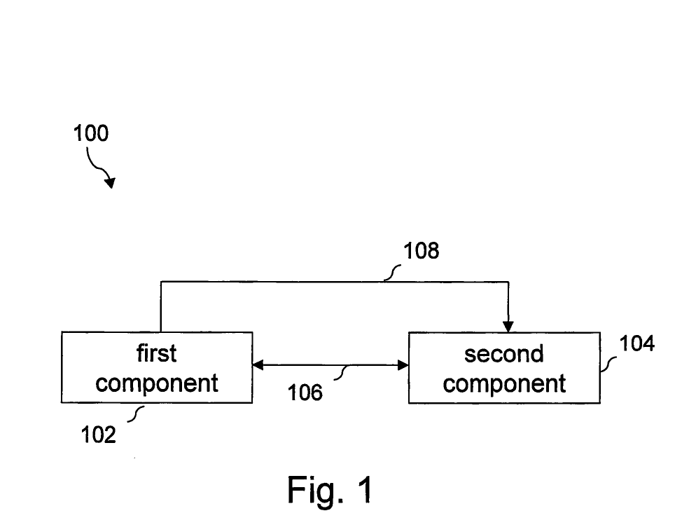

FIG. 1 is a schematic representation of a first embodiment of a home entertainment system;

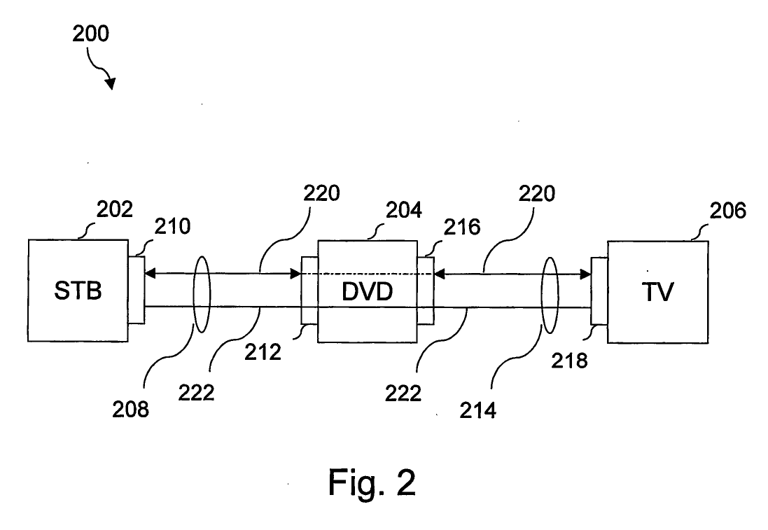

FIG. 2 is a schematic representation of a second embodiment of a home entertainment system; and

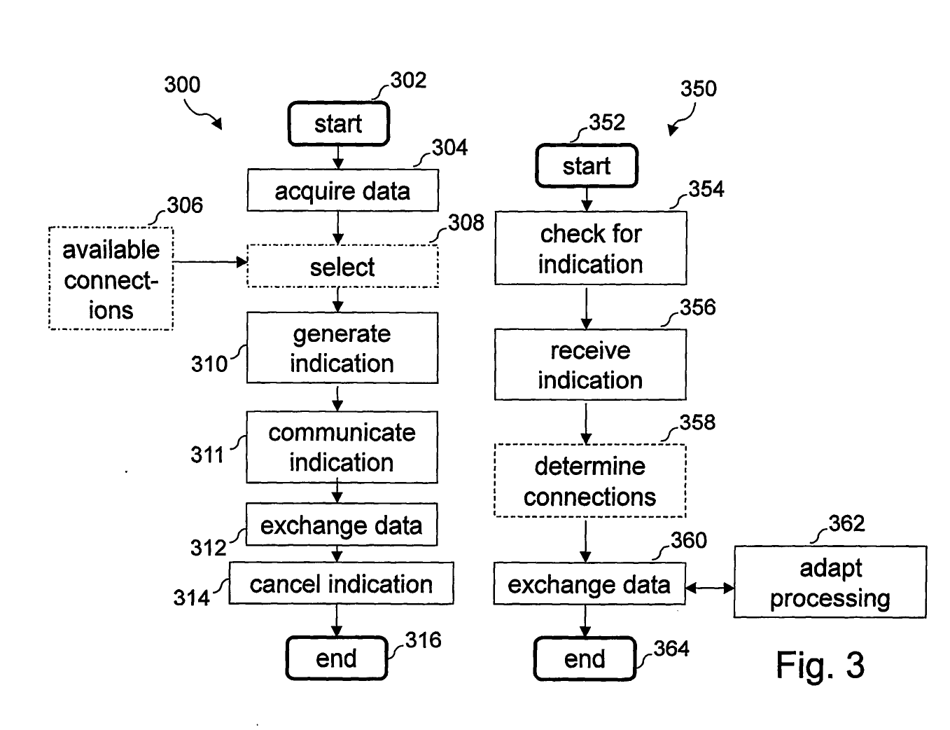

FIG. 3 is a flow diagram of a method according to the invention.

Within the present description the term ‘analogue AV content connection’ refers to a connection between components of a home entertainment system which is compatible with any of baseband audio, composite video, component video (including but not limited to Y, C, R, G, B), blanking signals associated with audio or video; the term also includes other compatible connections including RF and IR (wired or wireless).

FIG. 1 shows a schematic representation of a first embodiment of a home entertainment system. The system is shown generally at 100 and comprises a first component 102 and a second component 104. The components are connected by at least one analogue AV content connection 106. This connection may be used to exchange data between the components in dependence on indication 108 generated by the first component 102 sent to the second component 104. The indication 108 may be transferred to component 104 separately as shown or via connection 106 (not shown)—that is, within the data exchange protocol itself. Options for separate transfer of the indication 108 to the second component 104 include, but are not limited to, IR, RF, separate analogue AV content connection and Project50 (the latter option may be preferred for efficiency and also since the components are likely to be interconnected using Scart). The second component adapts its processing of content associated with the at least one connection used for the data exchange according to the indication, for example where the second component is a TV, during data exchange, it may blank its display or present a default display. The indication may also identify to the second component the at least one connection 106 utilised for data exchange. The second component may also acknowledge the indication, as discussed earlier.

FIG. 2 shows a schematic representation of a second embodiment of a home entertainment system. The system is shown generally at 200 and comprises a set top box 202, a DVD player 204 and a TV 206. The set top box 202 has data to be sent to the TV 206 (for example to upgrade software in the TV, a menu for display or perhaps digital AV content such as MPEG2 to stream to the TV). The Scart connector 210 of set top box 202 is connected by Scart cordset 208 to the Scart connector 212 of DVD player 204. Similarly, the Scart connector 216 of DVD player 204 is connected by Scart cordset 214 to the Scart connector 218 of TV 206. An analogue AV content connection 220 within the Scart interface is to be used to exchange data between set top box 202 and the TV 206; preferably the connection 220 is a bus type connection that is by default looped through intermediate components without any action needed by such components (in this example, Blanking pin 16 is used and is looped through the DVD player 204 as shown by the dashed line between Scart connector 212 and Scart connector 216). The indication from the set top box 202 in the example is performed by means of Project50 messages conveyed by conductor 222 (Scart pin 10) which is looped through all components of the system. The TV may, in response to the indication, adapt its processing of content by receiving data on pin 16 of the Scart whilst at the same time perhaps displaying a caption, muting the audio or performing similar actions. Alternatively, where the data is digital AV content (e.g. an MPEG2 stream), the TV may decode and present the content. The TV may acknowledge the indication via Project50 or via the data exchange, as discussed earlier. The example could in addition, or alternatively, utilise one or more other analogue AV content connections in place of Blanking; use of these may imply some loop through switching is necessary by the intermediate component (i.e. the DVD player 204), responding to the indication conveyed via Project50 messages. Furthermore the one or several analogue AV content connections may be dynamically re-configured during the course of a data exchange, in accordance with an indication/acknowledge dialogue between the set top box 202 and the TV 206, as discussed above.

By way of example, a set of Project50 messages and protocol are described below in relation to the system of FIG. 2, wherein the set top box component is denoted by the abbreviation STB. To initiate a data exchange, the STB indicates the data exchange mode to the TV by sending a Mode 3 Project50 message:
STB to TV <Request SCART Data Exchange> < . . . any optional parameters necessary . . . e.g. specified SCART analogue AV content connections to be used, etc. . . . >
   The TV may acknowledge the message by sending the following Mode 3 Project50 message to the STB:
TV to STB <Start Data Exchange > < . . . any relevant parameters . . . > which signifies that the STB can now start exchanging data with the TV.
   The intermediate component (the DVD in the example of FIG. 2) may also detect the initiating message above and might suitably configure its signal routing (e.g. by looping through) according to the specified analogue AV content connections. Similarly, to terminate the data exchange, the STB indicates to the TV the termination of the data exchange mode by sending a Mode 3 Project50 message:
STB to TV <Request SCART Data Exchange Termination>
   Again the TV may acknowledge by sending the following message:
TV to STB <Stop Data Exchange > < . . . any relevant parameters> ; which signifies that the STB can now stop exchanging data
   During a data exchange a new purpose-defined Project50 message type and protocol could be used, for example modelled on the Project50 Mode 1 message format, where first and second components vote within one message frame to indicate that they are active. This would facilitate messages to be repeated on a regular basis with possibly additional data included within the message, for example “bytes sent”, “bytes remaining”, flow control, changes to analogue AV content connections used, etc. An example is shown below where the new Project50 message is denoted as a “Mode 4 message”:
Mode 4 message: <Active First Component (BIT)> <Active Second Component (BIT)> <kByte Count Total> <kByte Count Exchanged> <flow control bits> <analogue AV content connection IDs>
   The Project50 Mode 4 message construction and protocol would preferably be defined to support data exchange at half duplex or full duplex using the specified analogue AV content connections. In this way its function resembles the upstream and downstream features of standard Project50 Mode 1 messages in relation to analogue AV content.

The foregoing Project50 implementation is presented by way of example only and represents one of a range of implementations that can readily be identified by a person skilled in the art to exploit the advantages of the present invention.

FIG. 3 is a flow diagram of a method according to the invention. The method is for a home entertainment system in which a first component intends to exchange data with a second component, the method comprises two parts shown generally at 300 and 350 for the first and second components respectively. For the first component the method starts at 302 and data is acquired 304. Optionally at 308 one or more analogue AV content connections may be selected from those available 306 for the data exchange. Determining which connections are available is outside the scope of the present description but might be conveniently performed by monitoring Project50 traffic or by other means readily identifiable by the skilled person. The first component then generates an indication 310 which is communicated 311 to at least the second component that a data exchange mode is to be entered. This indication optionally includes information identifying the connections selected from those available 306 for the data exchange. The indication may also be sent to other components in the system to enable them to configure where necessary to support the data exchange, as discussed above. At 312 the data exchange occurs. Once the present data exchange is completed, the first component then cancels the indication 314 to signal to at least the second component that the present data exchange mode is ended. The method for the first component ends at 316. For the second component the method starts at 352 and an indication is checked for at 354. The indication from the first component is received at 356. Optionally at 358 the second component determines which connections have been selected by the first component for the data exchange. Data is then exchanged with the first component at 360. During the data exchange the second component adapts its processing and other functions 362, for example routing/processing data exchanged with the first component in preference to handling analogue AV content normally exchanged using the connections selected by the first component for the data exchange. The method for the second component ends at 364. For clarity, FIG. 3 does not include the acknowledgement process discussed above.

The foregoing implementations and method are presented by way of example only and represent a selection of a range of implementations that can readily be identified by a person skilled in the art to exploit the advantages of the present invention.

In the description above and with reference to FIG. 2, a system 200 and method are described for exchanging data such as software updates, menus and digital AV content (e.g. MPEG2 streams) between components 202, 206 of a home entertainment system 200 interconnected using analogue AV connections such as phono/RCA or (preferably) Scart 208, 214. A first component 202 indicates 222 to a second component 206 that a data exchange is planned utilising one or more available analogue AV connections 220. In response, the second component 206 adapts its processing to accommodate the data exchange, for example routing and processing exchanged data instead of handling it as analogue AV content. In this way, existing analogue AV connections 208, 214 may be used to transfer data from one component to another in a home entertainment system without perturbing normal analogue AV operation whilst saving standardisation and deployment costs associated with defining new connectors and cordsets for such data transfer.

1. A home entertainment system comprising a first component (102) and a second component (104) connected using one or more interconnections for exchanging analogue AV content between the components, the components being operable to:
exchange analogue AV content using said interconnections, and, during a time interval,
exchange data content using at least one of said interconnections,
wherein, in relation to said time interval, the first component (102) is operable to:
a) generate an indication, and
b) communicate the indication to the second component (104), and the second component (104) is operable to:
I. receive the indication, and, in dependence on the indication,
II. adapt the processing of content associated with the at least one interconnection used for exchanging data content.

2. A home entertainment system as claimed in claim 1, wherein the second component is further operable, in dependence on the indication, to determine the at least one interconnection utilised to exchange data content with the first component.

3. A home entertainment system as claimed in claim 1, wherein the second component is operable to adapt the processing of content by inhibiting presentation of said content.

4. A home entertainment system as claimed in claim 1, wherein the interconnections for exchanging analogue AV content are those defined within the Scart specification.

5. A home entertainment system as claimed in claim 4, wherein the at least one interconnection utilised to exchange data content is the Blanking pin 16 of Scart.

6. A home entertainment system as claimed in any of claims 1 to 4, wherein the indication is communicated via means separate to the at least one interconnection utilised to exchange data content.

7. A home entertainment system as claimed in claim 6, wherein the indication is communicated by wireless means.

8. A home entertainment system as claimed in claim 4, wherein the indication is communicated by means of Project50 on pin 10 of Scart.

9. A method for exchanging data between a first component and a second component of a home entertainment system, which components are connected using one or more interconnections operable to exchange analogue AV content, the method comprising the steps of, for the first component:
a) acquiring (304) data to exchange with the second component;
b) generating (310) an indication which indicates a data exchange mode;
c) communicating (311) the indication to the second component;
d) exchanging data (312) with the second component using at least one of said interconnections; and
e) cancelling (314) the indication to indicate a cessation of the data exchange mode,
and the method comprising the steps of, for the second component:
I. checking (354) for an indication from components in the system;
II. receiving (356) the indication from the first component;
III. exchanging (360) data with the first component; and, in dependence on the indication,
IV. adapting (362) the processing of content associated with the at least one interconnection used for exchanging data content.

10. A method as claimed in claim 9, after step a) for the first component, further comprising the steps of:
determining (306) available analogue AV content interconnections with the second component; and
selecting (308) at least one of the available interconnections to use to exchange data.

11. A method as claimed in claim 9, after step 11 for the second component, further comprising the step of:
determining (358), in dependence on the indication, the at least one interconnection utilised to exchange data with the first component.

12. A method as claimed in any of claims 9 to 11, wherein the indication is communicated to all components of the home entertainment system thereby allowing the components to configure themselves in dependence on the indication.

13. A method as claimed in any of claims 9 to 12, wherein the second component acknowledges the indication to the first component.

14. A method as claimed in any of claims 9 to 13, wherein the second component, during the data exchange, communicates to the first component mode alterations in the availability of interconnections presently being used for data exchange.

15. A use of an at least one interconnection operable to exchange analogue AV content between components of a home entertainment system to, alternatively, exchange data between said components and, during the data exchange, to adapt the processing of content associated with the at least one interconnection by the components.

16. A use as claimed in claim 15, wherein the exchange of data is signalled by means of an indication.

17. A use as claimed in claim 15, wherein the rate of exchange of data is at least 10 kbit/sec.

18. A use as claimed in claim 15, wherein the at least one interconnection is embodied within the Scart specification.

19. A component of a home entertainment system, the component comprising software configured for carrying out the method steps as claimed in any of the claims 9 to 14.
